(19) United States
(12) Patent Application Publication
(10) Pub. No.: US 2005/0269814 A1
(43) Pub. Date: Dec. 8, 2005

(54) Book corner saver

(76) Inventors: Thomas Ray Dillavou, Lake Mills, IA (US); Gregory J. Knopf, Clear Lake, IA (US)

Correspondence Address: Warren Alexander Reiter, 150 N. Clark St., Forest City, IA, 50436, US

(21) Appl. No.: 11/139,140

(22) Filed: May 27, 2005

Related U.S. Application Data
(60) Provisional application No. 60/578,116, filed on Jun. 7, 2004.

(51) Int. Cl. B42D 1/00

(52) U.S. Cl. 281/20

(57) ABSTRACT

The present invention relates to a corner protector composed of a single unit with an opening for receiving a book corner and means for securing the protector to the book.

### FEDERALLY SPONSORED RESEARCH

Not Applicable

### SEQUENCE LISTING OR PROGRAM

Not Applicable

### BACKGROUND—FIELD OF INVENTION

The present invention relates to a novel product for protecting the corners of a book, and more particularly is a simple an inexpensive device that does not requiring any folding.

### BACKGROUND—DESCRIPTION OF PRIOR ART

The covers of books are subjected to a variety of wear and tear. The corners of books are the most susceptible to damage from normal wear and tear. Several inventions have been described to protect book covers as well as the book corners in particular.

U.S. Pat. No. 6,419,274 to Geddes; U.S. Pat. No. 5,129,522 to Druskoci; U.S. Pat. No. 4,886,299 to Ducorday; U.S. Pat. No. 4,527,814 to Carter disclose various methods to protect the book cover as a whole. These inventions have several problems as describe in Geddes patent. The current invention does not try to protect the entire cove but focus exclusively on the covers the part of the book most likely to be damaged by normal wear and tear. Thus, do not have the problems associated with trying to cover an entire book or the damage that occurs to the cover since it covers the entire book.

Lee, U.S. Pat Nos. 5,626,366 and 5,533,758, and Gorski, U.S. Pat. Nos. 6,482,283 B2 and 6,224,955 B 1 disclose methods for protecting just the corners of a book. These patents require a complicated method of folding and made of materials that are susceptible to wear and tear themselves.

While the last two prior art devices considered above protect just the corner of a book, which is the subject of the present invention. The device employed by the present invention depart from the conventional concepts and designs taught by the prior art. In doing so, the present invention provides a device for protecting a book corner as describe by the above two patents, but it accomplishes the result in a different and improved manner. The current invention is a single unit made of strong and durable materials that does not require any folding but simply slips onto the book.

### SUMMARY OF THE INVENTION

The present invention is a corner protector designed to slip over the corners of a book. It is comprised of a single unit of injected plastic with an opening to receive a book. The single unit corner protector is attached to the book via a double-sided adhesive strip.

The advantages and novel features of the present invention, as well as details of an illustrated embodiment thereof, will be more fully understood from the following description and drawings.

### BRIEF DESCRIPTION OF THE DRAWINGS

Drawing Figures

FIG. 1 is a perspective view of the preferred embodiment of the device of the present invention on a book.

FIG. 2 is a perspective view of the preferred embodiment of the device of the present invention.

FIG. 3 is a perspective view of how the preferred embodiment of the device is attached to the book of the present invention.

### DETAILED DESCRIPTION OF THE PREFERRED EMBODIMENT

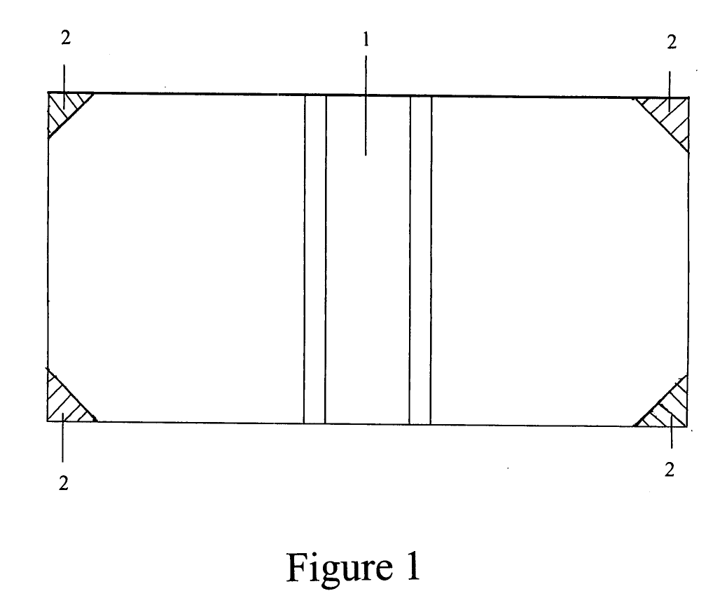

FIGS. 1-3 shows the book corner protector as contemplated by the present invention. The book corner protector 2 is comprised of a single unit that is made of molded plastic that is attached to the book 1 via an opening in the front of the unit 3. The book's corner protectors 2 are held in place on the book by a double-sided adhesive strip 4.

FIG. 1 shows how all four-corners of a book 1 would be protected by the corner protectors 2. A single unit is attached to each corner of the book 1, therefore reducing the wear and tear on the book corners. Since, the present invention only covers the book's covers the device is not subject to a lot of wear and tear itself as an entire book cover would be.

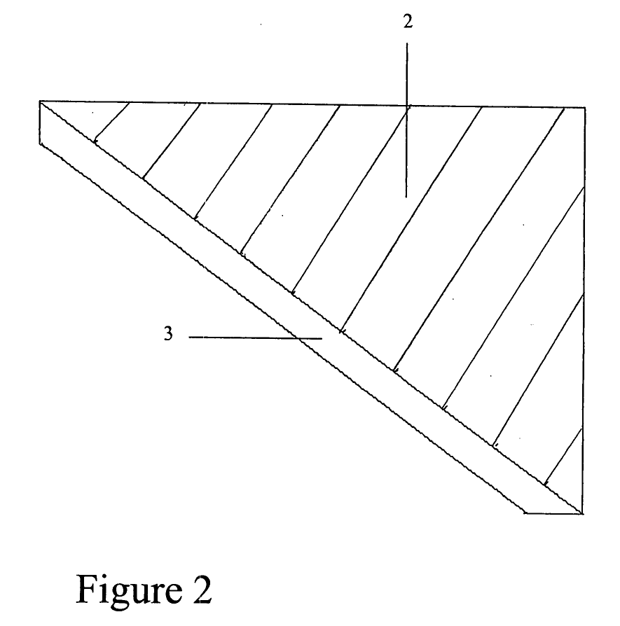

FIG. 2 shows the corner protector 2 with the opening on one side 3 to allow the device to slipped onto the book's corners. In the preferred embodiment, the corner protectors 2 are a single unit made of injected thermoplastic. Although, any injected plastic material would work. The advantages of injected thermoplastic are that it is a very strong material thus would be very resistant to wear and tear and does not require complex folding for attachment to the book. The corner protectors 2 would be injected at the require dimension to fit a given book.

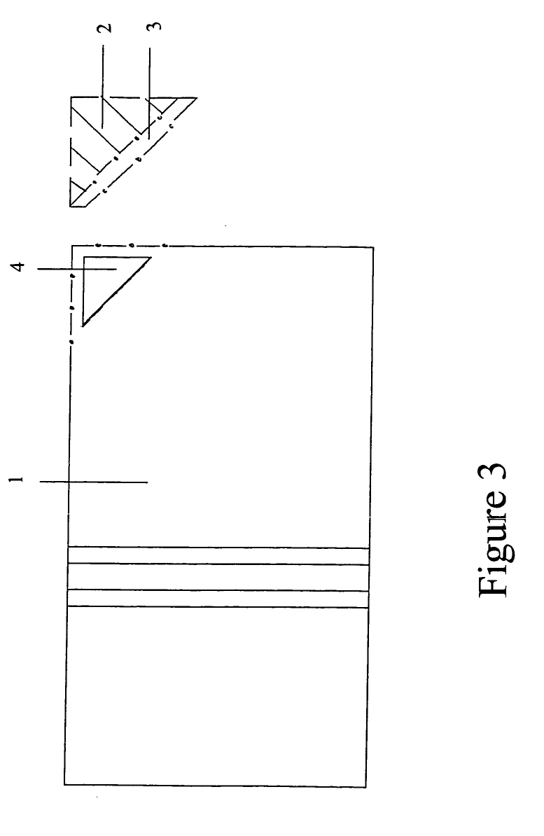

FIG. 3 shows how the attachment strip 4 is used to secure the corner protectors 2 to the book 1. The double-sided adhesive attachment strip 4 is secured to the book and the corner proctor 2 is slide onto the book 1 via the opening 3 where the other side of the double-sided adhesive attachment strip 4 adheres to the corner protector 2. The double-sided adhesive attachment strip 4, therefore keeps the corner protectors 2 securely attached to the book during normal usage.

In view of the above detailed description of the present invention and associated drawings, other modifications and variations will now become apparent to those skilled in the art. It should be apparent that such other modifications and variations may be effected without departing from the spirit and scope of the present invention.

1. A corner protector for protecting the comer's of books which is a single unit comprised of injected plastic.

2. The corner protector for protecting the comer's of books in claim 1 where the injected plastic is a thermoplastic.

3. The corner protector for protecting the comer's of books in claim 1 where corner protector is held in place by a double-sided adhesive attachment strip.

4. The corner protector for protecting the comer's of books in claim 1 where the injected plastic is a thermoplastic and the corner protector is held in place by a double-sided adhesive attachment strip.
